(19) United States
(12) Patent Application Publication
(10) Pub. No.: US 2026/0088885 A1
(43) Pub. Date: Mar. 26, 2026

(54) NEAR FIELD BEAM RANGE INDICATIONS FOR FR2/FR3 COMMUNICATION

(71) Applicant: QUALCOMM Incorporated, San Diego, CA (US)

(72) Inventors: Moshe BEN-ARI, Rehovot (IL); Itay IFERGAN, Tel Aviv - Jaffa (IL); Shay LANDIS, Hod Hasharon, Center District (IL); Gokul SRIDHARAN, Sunnyvale, CA (US)

(21) Appl. No.: 18/892,233

(22) Filed: Sep. 20, 2024

(51) Int. Cl. H04B 7/06; H04B 17/318; H04L 5/00

(52) U.S. Cl. CPC H04B 7/06958; H04B 17/328; H04L 5/0048

(57) ABSTRACT

Methods and apparatuses are provided for indicating and utilizing beam focusing ranges in near-field communication for beam refinement processes in millimeter-wave (mmWave) and higher frequency range (such as sub-Terahertz) systems. A user equipment (UE) receives a configuration from a network entity indicating a plurality of reference signal resources, each corresponding to an angular direction and a beam focusing range. The UE receives reference signal transmissions, measures signal quality metrics for each transmission, and transmits feedback to the network entity with recommendations for optimal beam selection. This process enhances the beam refinement by incorporating range focusing in addition to spatial sweeping, ensuring optimal signal reception and improved communication performance in near-field scenarios. Thus, the disclosed methods and apparatuses provide more precise beam alignment, better signal quality, and efficient use of the spectrum, particularly in dense urban environments.

### TECHNICAL FIELD

The present disclosure generally pertains to the field of wireless communication, and more particularly, to methods and apparatuses for indicating and utilizing beam focusing ranges in near-field communication for frequency range 2 (FR2), frequency range 3 (FR3), or other higher frequency systems.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, which may be a user equipment (UE). The apparatus includes one or more memories, and one or more processors each communicatively coupled with at least one of the one or more memories. The one or more processors, individually or in any combination, are operable to cause the apparatus to receive, from a network entity, a configuration indicating a plurality of reference signal resources, the reference signal resources each corresponding to an angular direction and a beam focusing range; receive a plurality of reference signal transmissions from the network entity, the reference signal transmissions being respectively received in beams corresponding to the angular directions and the beam focusing ranges; obtain a signal quality metric for each of the received reference signal transmissions; and transmit, to the network entity, feedback based on the signal quality metrics, the feedback including a recommendation for a beam specified by one of the angular directions and one of the beam focusing ranges.

Another innovative aspect of the subject matter described in this disclosure may be implemented in a method for wireless communication performable at a UE. The method includes receiving, from a network entity, a configuration indicating a plurality of reference signal resources, the reference signal resources each corresponding to an angular direction and a beam focusing range; receiving a plurality of reference signal transmissions from the network entity, the reference signal transmissions being respectively received in beams corresponding to the angular directions and the beam focusing ranges; obtaining a signal quality metric for each of the received reference signal transmissions; and transmitting, to the network entity, feedback based on the signal quality metrics, the feedback including a recommendation for a beam specified by one of the angular directions and one of the beam focusing ranges.

Another innovative aspect of the subject matter described in this disclosure may be implemented in an apparatus for wireless communication, which may be a UE. The apparatus includes means for receiving, from a network entity, a configuration indicating a plurality of reference signal resources, the reference signal resources each corresponding to an angular direction and a beam focusing range; the means for receiving being further configured to receive a plurality of reference signal transmissions from the network entity, the reference signal transmissions being respectively received in beams corresponding to the angular directions and the beam focusing ranges; means for obtaining a signal quality metric for each of the received reference signal transmissions; and means for transmitting, to the network entity, feedback based on the signal quality metrics, the feedback including a recommendation for a beam specified by one of the angular directions and one of the beam focusing ranges.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram illustrating an example of a base station and a user equipment (UE) involved in wireless communication.

FIG. 4A-4B are diagrams illustrating examples of far-field beamforming and near-field beam focusing in different angular directions, respectively.

FIG. 5 is a diagram illustrating examples of near-field beam focusing in a same angular direction, where the focus is on a same direction but in different ranges.

FIG. 6 is a diagram illustrating an example of a radio resource control configuration the base station may send to a UE that includes a block of information regarding non-zero power channel state information reference signals.

FIG. 7 is a diagram illustrating an example of a call flow between a base station and a UE.

FIG. 8 is a flowchart of an example method of wireless communication performable at a UE.

FIG. 9 is a diagram illustrating an example of a hardware implementation for an apparatus that is a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

The evolution of wireless communication systems is steering towards the adoption of large antenna arrays and high-frequency bands, which are anticipated to be the cornerstone of wireless networks. These advancements are driven by the need to accommodate the ever-increasing demand for higher data rates, lower latency, and enhanced connectivity. The integration of large-scale antennas with high transmission frequencies introduces a paradigm shift in the operational dynamics of communication devices. Unlike traditional systems that predominantly function in the far-field region, characterized by planar wavefronts, the new generation of communication systems may often operate in the near-field or Fresnel region, where the wavefronts are spherical. This shift is significant since a substantial portion, if not the entirety, of a typical cell size in a wireless communication network may be within the near-field region.

Operating in the near-field region presents unique challenges and opportunities. The spherical wavefronts may engender a different approach to signal processing and beamforming compared to the planar wavefronts of the far-field. Traditional beamforming techniques, which assume a planar wavefront, may not be effective in the near-field, leading to the need for advanced algorithms that can accurately model and manipulate spherical wavefronts. This shift also impacts the design and deployment of antenna arrays, as the spatial resolution and the ability to focus energy precisely become more important.

In the context of far-field communication, traditional communication systems often employ large antenna arrays for beam steering and shaping. This technique involves directing the beam energy towards a specific spatial angle, which has the dual benefit of increasing the antenna gain in the desired direction while simultaneously reducing gain in other directions. This focused approach minimizes interference and facilitates multi-user operation, as users located at different angles relative to the transmitter can be served more effectively. The ability to steer and shape beams is a significant aspect of wireless communication systems, allowing for efficient use of the spectrum and improving overall system capacity.

However, in the context of near-field communication, the behavior of generated beams from large antenna arrays exhibits unique characteristics that are not present in far-field communication. One of the most notable effects is beam range focusing, where the beams not only achieve amplified gain in a specific angular direction but also in a specific range. Thus, the gain may be concentrated within a certain distance, leaving lower gain at both shorter and longer ranges. Moreover, beam focusing has the added benefit of reducing interference for other users who are in the same direction as the UE of interest.

Thus, traditional far-field beamforming configurations are designed to increase gain towards a specific angular direction and minimize interference in other angular directions. However, this approach does not account for the near-field scenario where UEs might be in the same angular direction but at different ranges. Near-field beam focusing addresses this limitation by allowing beams to be concentrated at specific ranges, ensuring that transmissions to different users do not interfere with each other, even if they are aligned in the same direction. By focusing the beam's energy at specific ranges, near-field systems can achieve higher gain and better signal quality for the intended UE than far-field systems. This precise focusing also reduces interference for other users, even if they are located in the same angular direction.

The ability to control both the angle and range of the beam provides a substantial advantage in dense urban environments, where multiple UEs are closely spaced, and interference management is significant. Furthermore, the near-field beam split effect supports advanced applications that require high precision and low latency. For example, augmented reality and autonomous vehicles can benefit from the enhanced spatial resolution and reduced interference provided by near-field beam focusing. The ability to deliver high-quality signals to specific locations at different frequencies ensures that these applications can operate reliably and efficiently.

Yet, in the context of near-field communication, the complexity of beam management increases due to the presence of multiple beams pointing in the same angular direction but focused at different ranges. Thus, it would be helpful to provide a refinement process that includes a sweep over range focusing, ensuring that the communication link is optimized not just in terms of direction but also in terms of distance. It would also be helpful for the refinement process to account for the unique characteristics of near-field communication, since the ability to focus beams at specific ranges may significantly enhance performance.

Current approaches for beam refinement, known as P-2, primarily deal with far-field communication. In this scenario, a base station performs a beam sweep using directional beams, and the UE measures the received signal quality to determine the best beam. However, this process does not account for range focusing, which is important in near-field communication. Therefore, it would be helpful for the refinement process in near-field communication to include a comprehensive sweep over range focusing. This involves not only adjusting the beams in the angular domain but also ensuring that they are focused at the correct ranges. By doing so, the communication system can achieve higher gain, better signal quality, and more efficient use of the spectrum.

Aspects of the present disclosure account for near-field scenarios by allowing the base station to scan not only directional beams but also range-focused beams. More particularly, aspects of the present disclosure enhance the beam refinement process in near-field communication by incorporating range focusing in addition to spatial sweeping. Traditionally, the base station performs a beam sweep over different spatial directions to identify the optimal beam for communication with the UE. However, this approach primarily addresses far-field communication and does not account for the unique characteristics of near-field communication, where beams can be focused at specific ranges. By extending the beam refinement process to include range focusing, the base station achieve a more precise and effective beam selection, optimizing the communication link in both the angular and range domains.

The base station may sweep over not only directional beams but also beams focused at different ranges, which results in more beams to scan and evaluate than in typical P-2 processes. This comprehensive sweep ensures that the base station may select beams that not only point in the optimal direction but also focus at the optimal range, thereby maximizing the signal strength and minimizing interference. This dual-domain focusing is particularly beneficial in dense urban environments, where multiple users may be located at different ranges but within the same angular direction. By focusing beams at specific ranges, the base station may serve multiple users more effectively, improving overall system capacity and user experience.

In various aspects, to enhancement the beam refinement process in near-field communication, the base station may provide additional signaling parameters to optimize the communication link between the base station and the UE. More particularly, the base station may signal the beam focusing range per channel state information reference signal (CSI-RS) allocation. This signaling may allow the UE to align its own beam to the same range, both during the measurement process and for future communication, particularly if the base station performs a beam switch and sends an indication of it. For example, the base station may signal the beam focusing range in a dedicated field for this purpose, represented by beamFocusingRange or another name, within a radio resource control (RRC) parameter. For instance, the base station may indicate the beam focusing range in a field of a non-zero power CSI-RS resource parameter represented by NZP-CSI-RS-Resource or another name. Using this field, the base station may provide the UE with precise information about the range at which each beam is focused, allowing the UE to obtain more accurate and reliable measurements and better alignment of the UE's transmission and reception beams during and outside of the beam refinement process.

The allocation of this field may be approached in one of multiple ways, each particularly in regard to the number of bits added to the information block and the overall signaling efficiency. In one approach, the UE may allocate the beamFocusingRange field with multiple bits, allowing for high resolution and highly accurate values. The field may indicate an absolute range or a differential range relative to a current serving beam. In either case, this method may ensure that the range information provided to the UE is precise, allowing the UE to align its beams with a high degree of accuracy. The high-resolution allocation is particularly beneficial in scenarios where fine-grained control over beam focusing is required, such as in dense urban environments with closely spaced users.

In another approach, the beamFocusingRange field may be allocated with a smaller number of bits, for example generating a pointer or index to a table with low granularity. This approach has the advantage of saving the amount of added bits, reducing the overhead associated with the signaling process. By using a table with predefined range values, the base station may convey the range information to the UE with fewer bits, making the signaling process more efficient. This method is particularly useful in scenarios where the beam focusing ranges are not linearly spaced, as the table may be designed to accommodate non-linear spacing. Non-linearly spaced ranges are beneficial in near-field communication, where the separation between focused beams may vary at different distances.

In a further approach, the base station may indicate which approach is applied to the beamFocusingRange field. The choice between high-resolution allocation and low-granularity table indexing may depend on the specific requirements of the communication system and the trade-offs between accuracy and signaling efficiency. For example, high-resolution allocation may provide precise range information, allowing for optimal beam alignment and enhanced communication quality, but at the cost of increased signaling overhead. On the other hand, low-granularity table indexing may sacrifice some degree of accuracy in range information, but it may also reduce the signaling overhead and allow for flexibility in designing the range values, accommodating non-linear spacing and making it suitable for various near-field communication scenarios.

As a result, from the base station signaling the beam focusing range along with the beam refinement process and the subsequent beam switch to a specific beam, the UE may gain valuable knowledge about the beam focusing range. This information may allow the UE to generate its own best transmission or reception beams towards the base station, aligning them with the base station's focused range. This alignment may also allow for the UE's beams to be optimized for the best possible link budget, enhancing the communication quality and reliability. For example, the UE may dynamically adjust the transmission or reception beams based on the base station's range focusing information, which is a significant improvement over traditional far-field communication systems where such precise targeting may not be possible.

Furthermore, the information of the UE's distance to the base station from this signaling may be leveraged for positioning calculations and refinement. For instance, by ascertaining the range focusing distance of the beams, the UE may determine its distance from the base station, which can be used for triangulation and other positioning methods. This capability enhances the accuracy of positioning services, which are important for various applications such as navigation, location-based services, and emergency response. Thus, the ability to accurately determine the UE's position based on the base station's range focusing information adds another layer of utility to the communication system, making it more versatile and effective.

Accordingly, various aspects of the subject matter described in this disclosure relate generally to wireless communication systems, and more particularly to methods and apparatuses for indicating and utilizing beam focusing ranges in near-field communication for millimeter-wave (mmWave) and higher frequency systems, such as sub-Terahertz. Some aspects specifically relate to enhancing the beam refinement process by incorporating range focusing in addition to spatial sweeping. In various examples, apparatuses and methods are provided in which a UE receives a configuration indicating a plurality of reference signal resources, each corresponding to an angular direction and a beam focusing range; receives a plurality of reference signal transmissions from the network entity, respectively received in beams corresponding to the angular directions and the beam focusing ranges; obtains a signal quality metric for each of the received reference signal transmissions; and transmits feedback to the network entity based on the signal quality metrics, including a recommendation for a beam specified by one of the angular directions and one of the beam focusing ranges. In some examples, the UE adjusts its reception beam range to align with the respective beam focusing ranges during beam refinement, and adjusts its transmission or reception beam to align with the beam focusing range after beam refinement for subsequent communication with the network entity. Additionally, the UE may use the range focusing information to determine its distance from the base station, which can be leveraged for accurate positioning calculations, enhancing the performance of navigation, location-based services, and emergency response systems.

Thus, particular aspects of the subject matter described in this disclosure may be implemented to realize one or more potential advantages. For example, the disclosed methods and apparatuses may enhance the accuracy and reliability of communication links by allowing for precise beam focusing in both the angular and range domains. Moreover, the ability to dynamically adjust beams based on range focusing information can significantly improve the link budget and overall communication quality, particularly in dense urban environments. Additionally, the enhanced positioning capabilities provided by accurate range information can support advanced applications such as navigation, location-based services, and emergency response, making the communication system more versatile and effective.

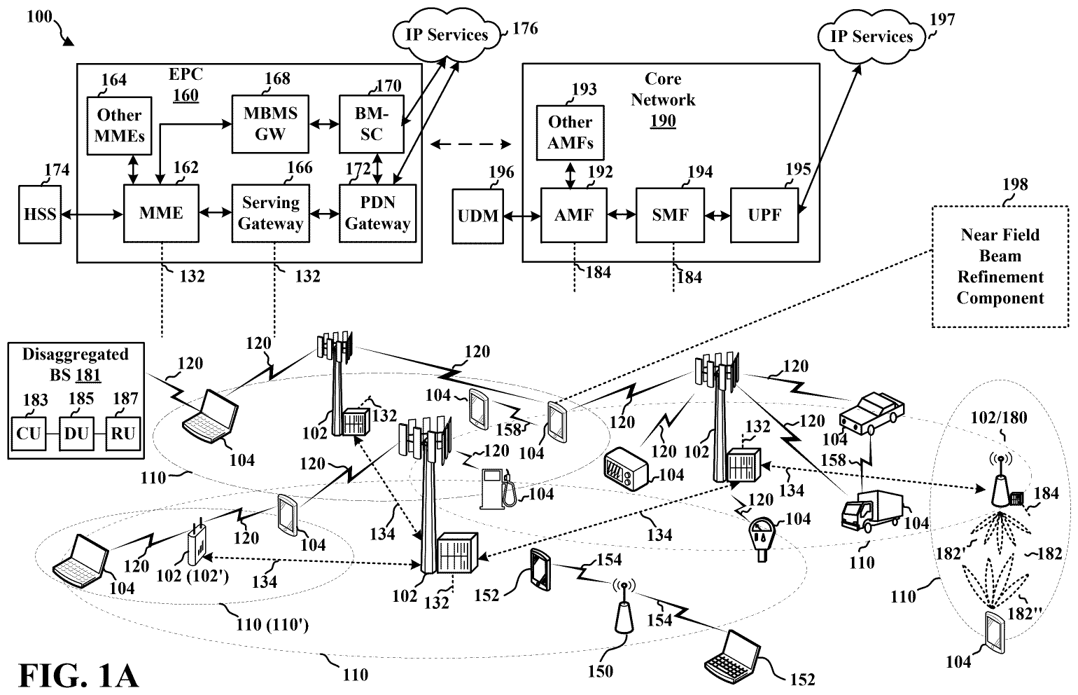

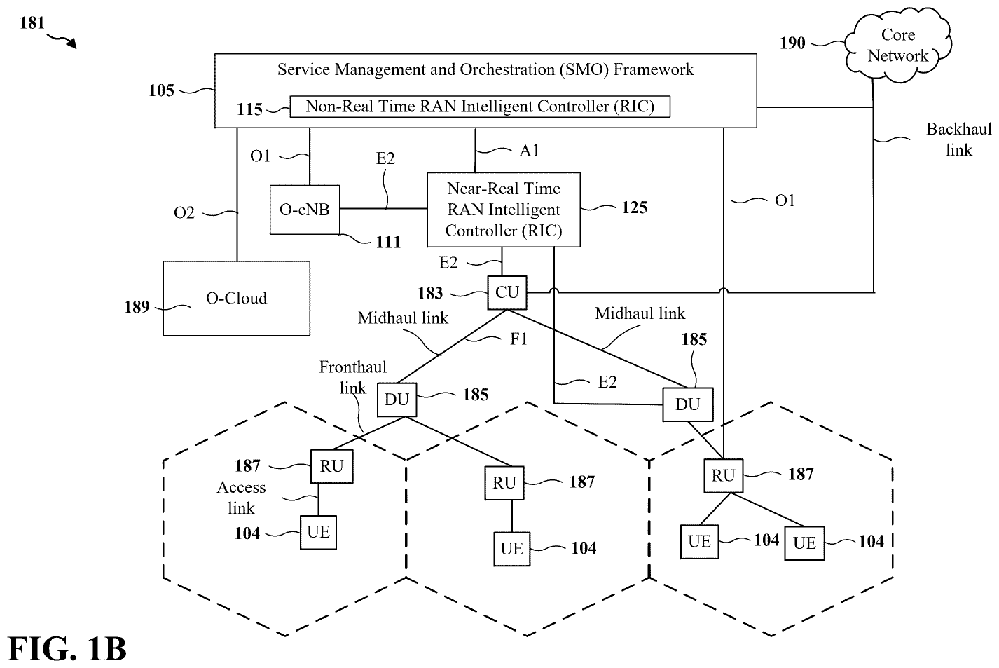

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring to FIGS. 1A and 1B, in certain aspects, the UE 104 may include a near field beam refinement component 198 that is configured to receive, from a network entity, a configuration indicating a plurality of reference signal resources, the reference signal resources each corresponding to an angular direction and a beam focusing range; receive a plurality of reference signal transmissions from the network entity, the reference signal transmissions being respectively received in beams corresponding to the angular directions and the beam focusing ranges; obtain a signal quality metric for each of the received reference signal transmissions; and transmit, to the network entity, feedback based on the signal quality metrics, the feedback including a recommendation for a beam specified by one of the angular directions and one of the beam focusing ranges. The network entity may be, for example, a base station (BS 102/180), disaggregated base station 181, or a component of a disaggregated base station such as CU 183, DU 185, or RU 187.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

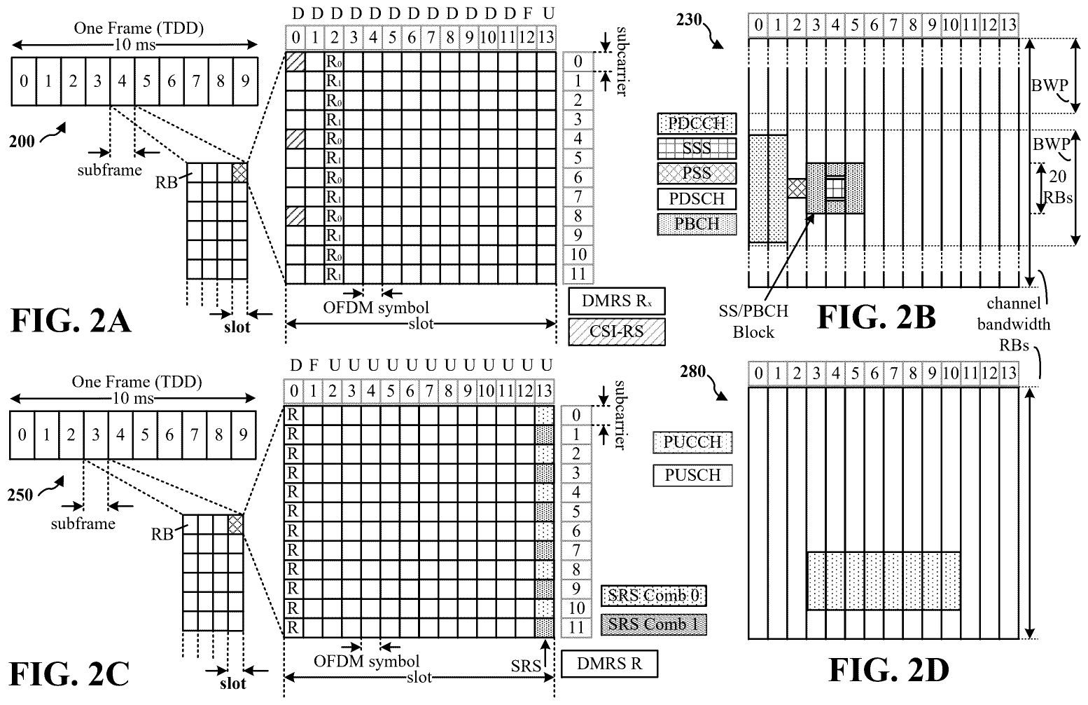

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

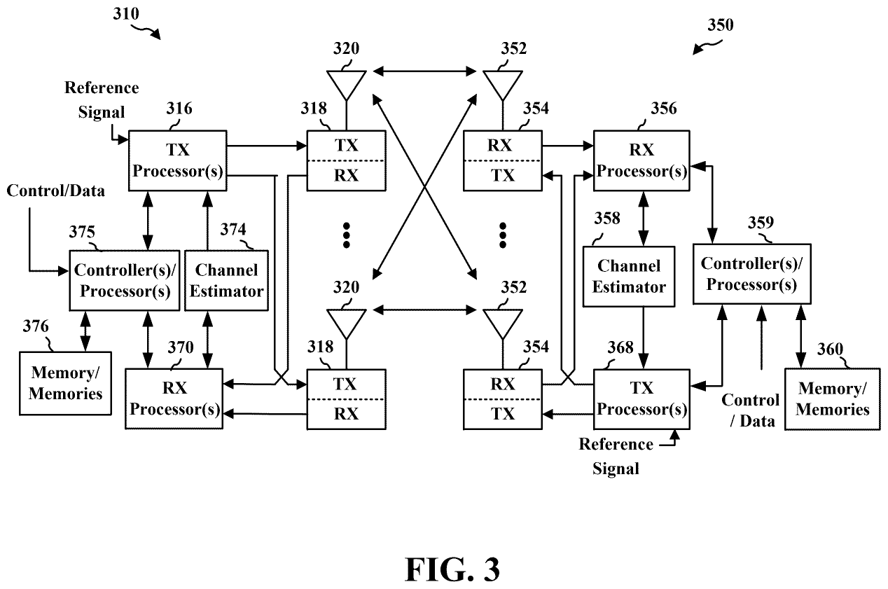

FIG. 3 is a block diagram of a base station 310 such as base station 102/180 in communication with a UE 350 such as UE 104 in an access network. IP packets from the EPC 160 may be provided to one or more controllers/processors 375 of base station 310. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 of base station 310 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 of UE 350 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359 of UE 350, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with transmission by the base station 310, the one or more controllers/processors 359 of UE 350 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359, may be configured to perform aspects in connection with near field beam refinement component 198 of FIG. 1A.

Wireless communication systems are transitioning to larger antenna arrays and higher frequency bands. This transition may result in entering a near-field communication zone, as opposed to the far-field that is typically associated with several communication systems. The distinction between near-field and far-field regions is pivotal for optimizing system performance. When the assumptions of far-field operation are no longer valid, communication performance may be constrained in various ways. This prompts for a thorough understanding and consideration of these limitations. Conversely, the unique characteristics of the near-field region may be leveraged to enhance performance. Therefore, recognizing whether a system is operating within the near-field or far-field is important for achieving optimal performance.

The theoretical calculation of the limit between far-field and near-field becomes smaller as we move to larger antennas and higher frequency bands. This limit may be defined by the Fraunhofer distance, denoted as dF, which may be calculated using the formula d_{F}=2D²/λ, where D represents the aperture of the antenna array, and λ is the wavelength of the transmitted signal. For instance, consider an antenna with a 0.5-meter aperture operating at a carrier frequency of 145 GHz. After converting the carrier frequency to its corresponding wavelength and plugging the values into the Fraunhofer distance formula, a distance dF of approximately 240 meters may be obtained. This distance is significant since most of the cell range in these frequencies may not usually go beyond 240 meters, implying that most of the cell may be in the near-field.

In traditional far-field systems, beams are typically focused towards a specific direction, allowing for targeted energy delivery to a specific user. This results in a larger gain for the intended user and reduced interference for others. The ability to generate multiple beams pointing in different directions is a significant advantage of antenna arrays, as it allows for more efficient and effective communication. However, when the far-field assumptions are no longer met, the performance of these systems can be impacted. The far-field region is characterized by planar wavefronts, which simplify the design and implementation of beamforming techniques. In contrast, the near-field region is defined by spherical wavefronts, which require more complex signal processing and beamforming algorithms. The transition from far-field to near-field operation introduces new challenges, such as the need for precise modeling of spherical wavefronts and the development of advanced algorithms to manipulate these wavefronts effectively.

Despite these challenges, the near-field region also offers opportunities for performance enhancements. For instance, the ability to focus energy more precisely in the near-field may lead to improved spatial resolution and better interference management. This can be particularly beneficial in dense urban environments, where the ability to distinguish between closely spaced users is important. Additionally, the near-field region may support new applications and services that require high precision and low latency, such as augmented reality and autonomous vehicles. Thus, understanding the behavior of beams in both far-field and near-field regions is important for optimizing system performance.

Beam focusing is a distinctive feature of near-field communication that does not occur in far-field beams. In near-field communication, each beam is not only focused in a specific direction but also at a specific range. This allows for the generation of multiple beams pointing in the same direction, with each beam focused on a different range. This capability, known as beam range focusing, provides significant advantages. By concentrating the gain towards the desired UE within a specific range, the link budget is enhanced, resulting in better overall performance. The link budget, which is a measure of the total gain and loss in a communication system, is important for determining the quality and reliability of the communication link. In near-field communication, the ability to focus the beam precisely towards the intended UE ensures that the signal strength is maximized, thereby improving the link budget and enhancing the communication quality.

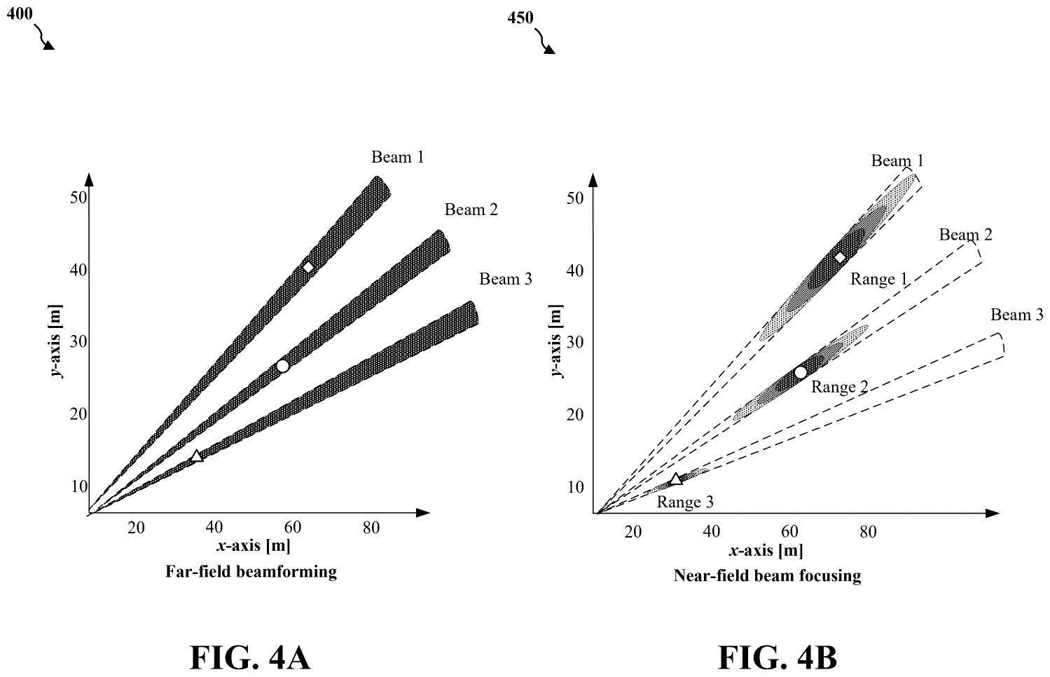

FIGS. 4A and 4B illustrate examples 400, 450 of far-field beamforming and near-field beam focusing in different angular directions, respectively. In the far-field region, beamforming occurs primarily in the angular domain. For instance, in the example 400 of FIG. 4A, the base station may steer three beams respectively to different users in different directions, although the number of beams, directions, or users may be different in other examples. Conversely, in the near-field region, beamforming occurs in both the angular and range domains. That is, unlike far-field beams, near-field beams may not only be steered in different directions but may also be focused at different distances. Thus, the gain of the beam may be concentrated at specific ranges. For instance, in the example 450 of FIG. 4B, the base station may not only steer beams respectively to different users in different directions similar to example 400 of FIG. 4A, but may also focus each beam to a respective range to maximize gain for each user. In the example of FIG. 4B, the gain for each beam is depicted using different pattern densities, with greater densities corresponding to higher gains in certain ranges and lesser densities corresponding to lower gains in other ranges. This range-specific focusing allows for more precise control over the beam's energy distribution, enhancing the ability to target specific UEs while minimizing interference with others.

Thus, in traditional far-field communication, beams are typically directed towards a specific angular direction, but they do not exhibit the same range-specific gain characteristics as near-field beams. In near-field communication, the focused beams ensure that the gain is concentrated only within a specific range, thereby minimizing interference for other users in the same direction. This capability is important for enabling better multi-user operability, as it allows multiple users to be served simultaneously without causing significant interference to each other.

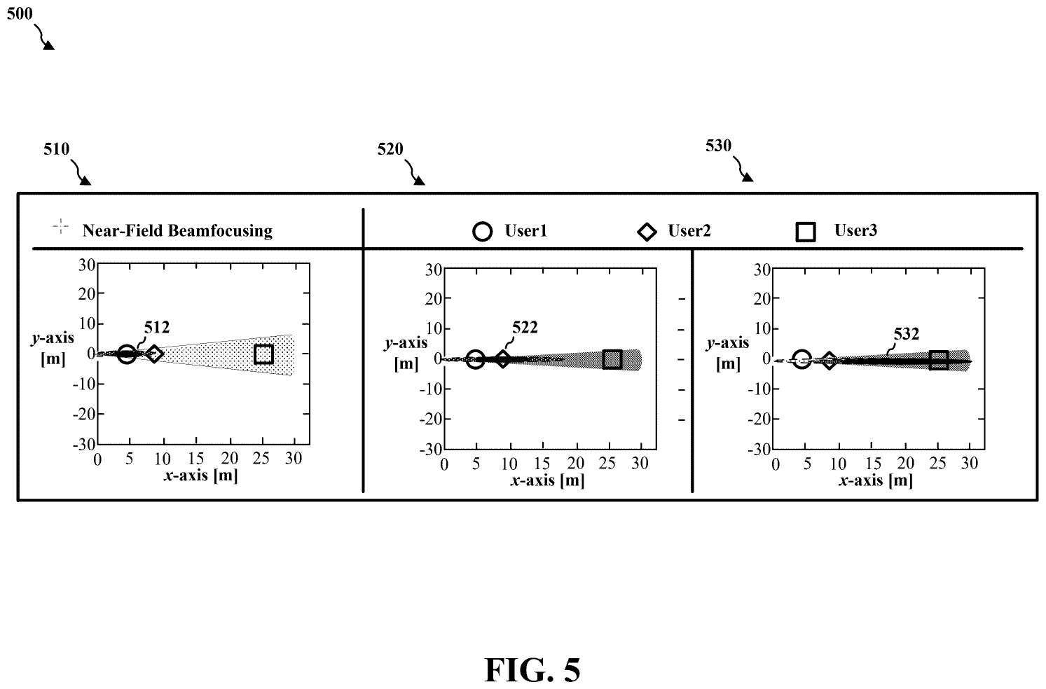

FIG. 5 illustrates examples 500 of near-field beam focusing in a same angular direction but over different ranges. In the realm of near-field communication, the concept of beam focusing extends beyond merely directing energy towards a specific angular direction. It also involves focusing the beam at specific ranges, which allows for more precise targeting of UEs. This capability is particularly advantageous in scenarios where multiple users are located in the same angular direction but at different distances from the transmitter. The different examples 510, 520, and 530 in FIG. 5 illustrates this phenomenon, showing how near-field beam focusing can serve multiple users in the same angular direction without causing interference, even when using the same time-frequency resources.

In the depicted scenario, three users (User1, User2, and User3) are aligned in the same angular direction. Traditional far-field communication would struggle to serve these users simultaneously without causing significant interference, as the beams would overlap in the angular domain. However, near-field beam focusing allows each beam to be concentrated at a specific range 512, 522, 532, ensuring that the transmissions to User1, User2, and User3 do not interfere with each other. This may be achieved for example by adjusting the phase and amplitude of the signals at the antenna elements, creating beams that are focused at different distances. By concentrating the beams at different distances, each user may receive the maximum possible gain while minimizing interference with others. Such difference in beam focusing may be seen in the example of FIG. 5, where different pattern densities corresponding to different gains are depicted for users at different ranges in a same angular direction.

Thus, this capability of near-field communication systems may enhance communication performance in dense environments. By focusing the beam's energy precisely at the intended user's range, near-field communication systems can achieve higher gain and better signal quality. This targeted approach not only improves the link budget but also minimizes interference for other users, even if they are located in the same direction. The ability to serve multiple users simultaneously without interference is important for maximizing the efficiency of the available spectrum and improving overall system capacity. Moreover, the use of the same time-frequency resources for multiple users in the same angular direction underscores the efficiency of near-field beam focusing. In traditional systems, serving multiple users would typically require different time or frequency slots to avoid interference, leading to less efficient use of the spectrum. Near-field beam focusing, however, allows for concurrent transmissions on the same time-frequency resources by spatially separating the beams in the range domain. This spatial separation ensures that each user receives a high-quality signal without being affected by the transmissions to other users.

Additionally, in the context of 5G NR, the procedure of beam refinement, often referred to as P-2, plays a significant role in optimizing communication between the base station and UE. This process involves the base station performing a beam sweep and transmitting a nonzero power channel state information-reference signal (NZP-CSI-RS) waveform, while the UE uses a fixed beam to receive the NZP-CSI-RS over different transmission beams. The primary objective of this procedure is to identify the most suitable beam for future communication, thereby enhancing the link quality and overall system performance.

The beam refinement process typically occurs after the initial acquisition stage, during ongoing communication between the base station and the UE. Since the scenario is usually not fully static, with UEs moving around and changing their relative angular direction with the base station, it becomes important to periodically reselect the serving beam. This ensures that the base station continues to use the most effective beam to serve the UE, maintaining high-quality communication.

During the beam refinement process, the base station sends out multiple beams, each carrying the NZP-CSI-RS waveform. The UE, having determined the schedule of these beams, measures the received signal quality metrics such as signal-to-noise ratio (SNR), signal-to-interference-plus-noise ratio (SINR), or reference signal received power (RSRP). Based on these measurements, the UE determines which beam provides the best communication link and reports this information back to the base station. The base station then typically switches to the recommended beam, optimizing the communication link.

However, the current beam refinement procedure in 5G NR focuses solely on different angular beams. Thus, the base station sweeps through beams directed at various angles but does not account for near-field beam focusing. Near-field beam focusing involves not only directing beams at specific angles but also focusing them at specific ranges. If near-field beam focusing were incorporated in the P-2 process, the base station would be able to achieve more precise targeting of UEs, especially in dense urban environments where multiple users are located at different ranges but within the same angular direction. This would allow for more efficient use of the available spectrum and reduce interference, thereby improving overall system capacity and user experience. Similarly, the incorporation of near-field beam focusing could result in similar benefits to other beam processes, including for example, P-1 (SSB scanning) or P-3 (UE beam refinement for SRS).

Thus, aspects of the present disclosure provide for enhancements to at least the P-2 process by incorporating near-field beam focusing, thereby providing more precise targeting and reducing interference. Moreover, assuming that the UE also employs an antenna array, aspects of the present disclosure provide for the UE to obtain accurate information about its range to the base station. This information may be important for at least three primary reasons. First, from this information, the UE may focus its own reception (Rx) beam to the same range that the base station is focusing on during beam refinement. This alignment ensures that the measurements taken by the UE are the most reliable, as the beam is precisely targeted at the intended range. Accurate measurements are important for determining the best beam for communication, thereby optimizing the link quality and overall system performance. Second, from this information, the UE may switch its own Rx beam when communicating with the base station to achieve the best link budget after beam refinement. The link budget, which is a measure of the total gain and loss in a communication system, is important for maintaining a high-quality communication link. By aligning its Rx beam with the base station's focused range, the UE may maximize the received signal strength, thereby improving the link budget and enhancing the communication quality. This dynamic adjustment of the Rx beam is significant for maintaining robust and efficient communication, especially in environments with varying signal conditions and user mobility. Third, in addition to optimizing the communication link, this information of the UE's range to the base station may be leveraged for positioning calculations and refinement. For instance, positioning of the UE may be achieved through triangulation, provided the UE is informed of or determines the locations of multiple base stations and the UE's range to each of them. Triangulation involves using the determined positions of multiple base stations and the measured distances to the UE to calculate the UE's precise location. This method may significantly enhance the accuracy of positioning services, which are important for various applications such as navigation, location-based services, and emergency response.

In various aspects, the base station may signal the P-2 range focusing distance of each beam applied in its near-field beam refinement process as part of a channel state information-reference signal (CSI-RS) configuration within a radio resource control (RRC) configuration. This signaling may provide the UE with information about the range at which each beam is focused, allowing the UE to make more informed decisions during the beam refinement process. From ascertaining the range focusing distance, the UE may align its own transmission and reception beams to the same range, ensuring that the measurements taken are the most accurate and reliable. This alignment may also serve to optimize the link budget and enhance the overall communication quality.

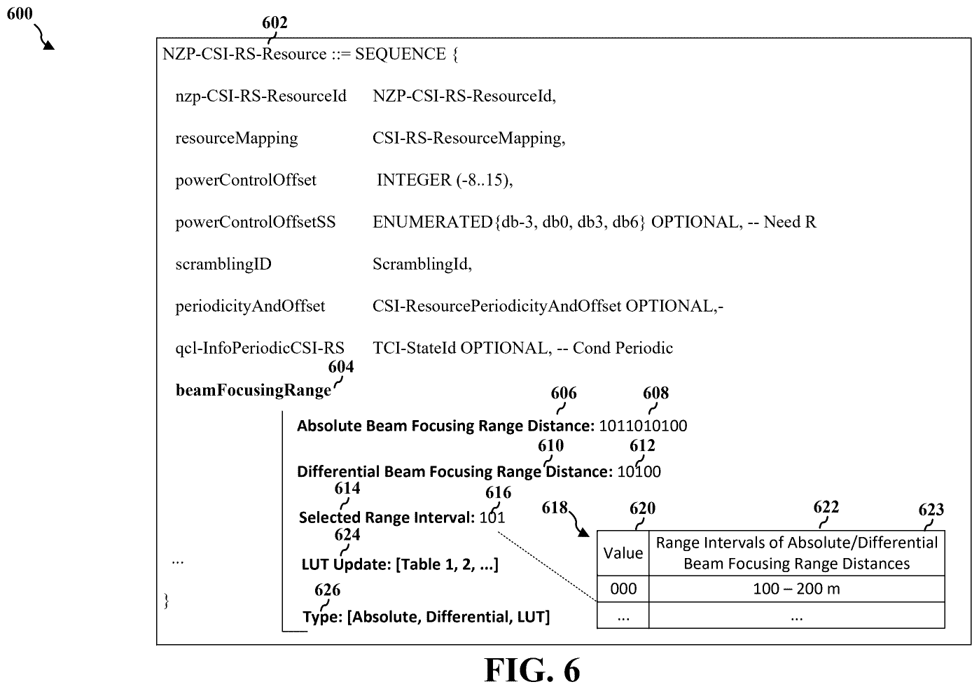

FIG. 6 illustrates an example 600 of an RRC configuration the base station may send to the UE that includes a block 602 of information regarding the non-zero power CSI-RS. This block may contain several fields, including a non-zero power CSI-RS resource identification, resource mapping information, a power control offset, a scrambling ID, a periodicity and offset, and quasi-colocation information. In various aspects of the present disclosure, an additional field 604 may be added to this block of information, which may include the range focus for each of the beams that will be scanned during the P-2 process. This additional field 604 may provide the UE with important information about the range at which each beam is focused, allowing the UE to make more informed decisions during the beam refinement process.

More particularly, in the example 600 of FIG. 6, the signaling of the beam focusing range may be integrated within an RRC parameter NZP-CSI-RS-Resource, although in other examples the range may be integrated within a different RRC parameter. This integration may involve adding field 604 to the sequence or block 602, allowing the base station to convey the range information to the UE. By signaling the beam focusing range field within the NZP-CSI-RS-Resource sequence or other RRC parameter sequence, the base station may allow the UE to focus its own beam to the same range as the base station during the measurement process. This alignment may ensure that the measurements taken by the UE are accurate and reliable, as the beam is precisely targeted at the intended range, as well as help the UE in determining the best beam for communication. Moreover, the signaling of the beam focusing range may allow the UE to adjust its transmission and reception beams for future communication. Thus, if the base station performs a beam switch and sends an indication of it, the UE may dynamically adjust its beams to align with the new focused range and thus maintain a high-quality communication link with beams optimized for the best possible link budget. Furthermore, the signaling of the beam focusing range may enhance the UE's ability to perform positioning calculations. From this information, the UE may determine its distance from the base station for triangulation and other positioning methods and thereby improve the accuracy of positioning services.

The allocation or signaling of this field 604 may be approached in several ways. In one approach, the field 604 may indicate an absolute beam focusing range distance 606 corresponding to a fixed point binary representation 608 of an integer. For example, the base station may allocate the beamFocusingRange field with a large number of bits, such as 10 bits, which can represent integer ranges up to 1 kilometer or other large distances. This method may provide full-range accurate information, ensuring that the range data is highly precise. For example, if the range is measured in meters, 10 bits can signal a precise distance of up to 1024 meters, offering the best granularity. This method provides the most accurate information, allowing the UE to ascertain the exact range and align its beams accordingly. This high-resolution allocation is particularly beneficial in scenarios where fine-grained control over beam focusing is important, such as in dense urban environments with closely spaced users. The ability to provide highly accurate range information allows the UE to optimize its link budget and enhance overall communication quality, as the beams can be precisely targeted at the intended range.

Another approach is to represent the beamFocusingRange differentially, relative to the current serving beam. Thus, the field 604 may indicate a differential beam focusing range distance 610 corresponding to a fixed point binary representation 612 of an integer. This method provides for the P-2 process to scan only a small portion of distances around the serving beam. By using a smaller number of bits, such as 5 bits, the entire scan range may be represented with a same or similar level of accuracy as in the absolute distance approach. For example, if the current serving beam is focused at 500 meters and 5 bits are used with the least significant bit (LSB) representing 1 meter, the differential representation may signal a ±16 meter difference from this range, in response to which the UE may determine the beam is focused somewhere between 484 and 516 meters. Similarly, if 5 bits are again used in the 500 meter example but the LSB represents 2 meters, the differential representation may signal a ±32 meter difference from this range, in response to which the UE may determine the beam is focused somewhere between 468 and 532 meters. The current serving beam range, number of bits, and LSB representation may be different in other examples. This method reduces the signaling overhead of the absolute distance approach while still providing accurate range information for the UE to align its beams, as the UE is unlikely to move drastically within a single beam refinement period. The differential representation may be particularly useful in scenarios where the range variations are relatively small, allowing for efficient and precise beam alignment without the need for a large number of bits, and making it efficient to scan beams within a nearby range.

A further approach involves representing the beamFocusingRange using an enumeration or look-up-table (LUT) pointer. For instance, the field 604 may indicate a selected range interval 614 corresponding to a fixed point binary representation 616 of an integer corresponding to an index of a LUT 618. In this example, the LUT 618 may include indices or values 620 associated with different range intervals 622 of absolute beam focusing range distances from which the selected range interval 614 is chosen. Thus, this approach can cover the entire expected range interval with an even smaller number of bits, such as 3 bits, which may indicate up to a certain number of different range intervals, such as 8 different range intervals. For example, the LUT 618 may have entries where the first index represents one interval of 0 to 99 meters, the second index represents another interval of 100 to 200 meters, and so on up to eight different indices and corresponding range intervals. Moreover, the range intervals may be non-linearly spaced, providing flexibility in accommodating various near-field communication scenarios. The UE and base station may both ascertain the information in this table, and the base station may simply signal the selected range interval 614 or other index of the LUT 618 to the UE, significantly saving on information bits. The table-based approach is particularly useful in scenarios where the beam focusing ranges do not need to be linearly spaced, allowing for efficient signaling with minimal overhead. Although the UE may not be able to determine from the signaling the exact distance, the UE may be able to determine the beam is focused within the specific range interval indicated, significantly reducing the signaling overhead at the sacrifice of some accuracy. The base station may decide the exact range within the specified interval, providing flexibility in beam management.

An additional, hybrid approach combines the differential and table-based approaches by providing the LUT 618 to include entries that represent differential ranges relative to the serving beam, allowing for precise yet efficient signaling. For instance, the aforementioned, LUT 618 may in this example include indices or values 620 associated with different range intervals 623 of differential beam focusing range distances from which the selected range interval 614 is chosen. This approach allows for a small number of entries in the table but provides better resolution than using a table with absolute distances alone, achieving an optimal trade-off between accuracy and efficiency. For example, if the current beam is at 500 meters, the table may have entries for one interval of 490-500 meters, another interval of 500-510 meters, and so on. This method provides finer granularity than the other example of the LUT 618 including range intervals 622 of absolute distances, thus balancing accuracy with signaling efficiency. Based on the signaling of field 604 in this hybrid approach, the UE may determine the beam is focused within a narrower range interval, such as 500-510 meters, providing more precise targeting than the broader intervals of the absolute distance LUT approach.

The lookup table approach, either for range intervals 622 of absolute distances or for range intervals 623 of differential distances, may also be enhanced by allowing for updates to the LUT 618 itself in the RRC configuration. For instance, the field 604 or a different field in the configuration may indicate whether or not an update to LUT 618 is to occur and which of multiple LUTs is to be applied. Thus, the base station may transmit beams over distances from different lookup tables at different times, ensuring the range values remain consistent and accurate over time. This capability adds flexibility, allowing the system to adapt to changing conditions and requirements.

In a further approach, the RRC configuration may semi-statically indicate which type 626 of the aforementioned approaches is to be used for a period of time. For instance, the field 604 or a different field in the configuration may indicate via type 626 or in a different manner whether the configuration includes an absolute bit value such as absolute beam focusing range distance 606, a differential bit value such as differential beam focusing range distance 610, or the lookup table approach such as selected range interval 614. This flexibility allows the system to adapt to different scenarios and requirements, optimizing the beam refinement process for various use cases. For example, the RRC configuration may indicate using the absolute distance approach with a specific number of bits for one refinement period and switch to the look-up table approach for another refinement period. This dynamic adjustment allows the system to optimize performance based on current conditions.

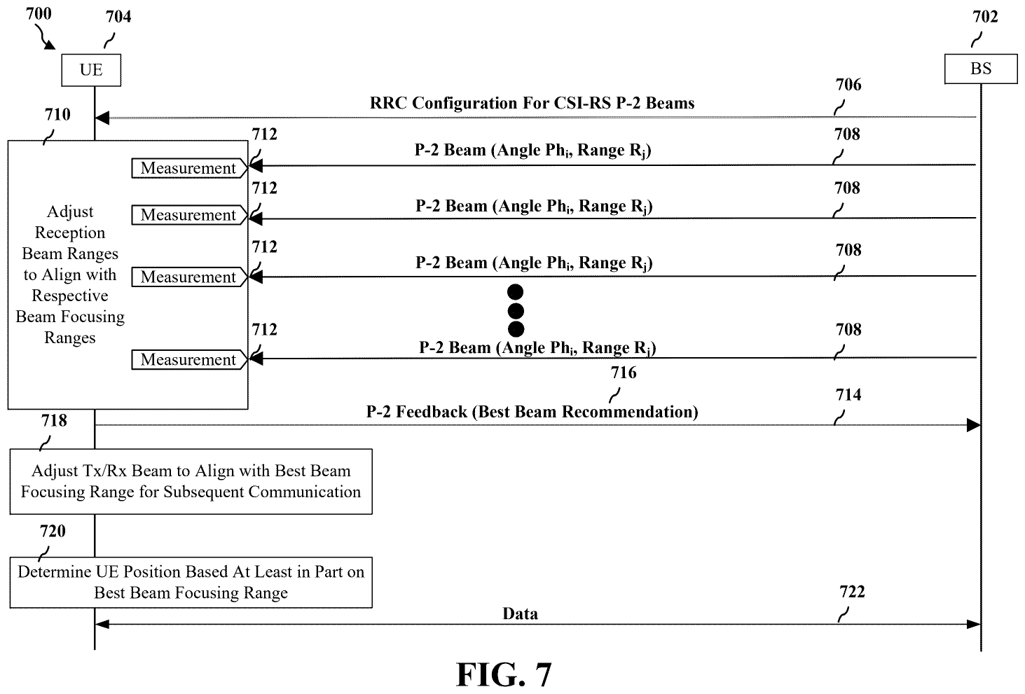

FIG. 7 illustrates an example 700 of a call flow diagram between a base station 702 and a UE 704 illustrating various aspects of the present disclosure. Here, base station 702 may correspond to base station 102, 310, and UE 704 may correspond to UE 104, 350. The illustrated example 700 depicts a beam refinement process in near-field communication for optimizing the communication link by allowing the UE to identify a best beam for transmission incorporating beam range focusing.

In the illustrated example, the process begins with the base station 702 sending an RRC configuration 706 for CSI-RS P-2 beams, although different reference signals or a different beam refinement process may be applied in other examples. This example configuration may include information about transmission beams that will be used in the P-2 process, specifying their angles and ranges. For example, the configuration 706 may include block 602 or other parameters indicating resource information for NZP-CSI-RS to be sent over transmission beams in various directions, such as over transmit directions 182′ of FIG. 1A. This resource information may impliedly indicate the steered direction or angle of each transmission beam, such as illustrated in the examples 400, 450 of FIGS. 4A and 4B, as well as expressly indicate the range or focusing distance of each transmission beam such as illustrated in the examples 510, 520, or 530 of FIG. 5. Alternatively, the configuration may include similar information for other reference signals than CSI-RS. With respect to the angle, the configuration 706 may not necessarily signal this information explicitly. For example, each beam may be associated with a different resource index corresponding to a different direction, allowing the UE and base station to differentiate between them without explicit angle signaling. However, with respect to the range, this information may be signaled explicitly. For instance, the configuration 706 may explicitly indicate the range or focusing distance of each transmission beam such as described with respect to FIG. 6. For example, the block 602 of resource information for NZP-CSI-RS may indicate the field 604 given by beamFocusingRange or other name, and the field 604 may indicate the absolute beam focusing range distance 606, the differential beam focusing range distance 610, the selected range interval 614, LUT update 624, type 626, or a combination of the foregoing information, as previously described. Alternatively, this information may be impliedly signaled similar to the angle in other examples, for instance, via correspondence with difference resource indices or in other manners.

After the RRC configuration 706 is transmitted, the base station may transmit multiple P-2 beams 708, each characterized by a specific angle (Phi) and range (R). Although FIG. 7 uses the same subscripts for angle (Phi) and range (R), it should be understood that either of these values may change with each transmission. For example, these beams may be sent sequentially with different angles and ranges, and the UE may at block 710 adjust its reception beam ranges to align with the respective beam focusing ranges indicated in the configuration 706 for each CSI-RS or P-2 beam 708. During this process, for each P-2 beam 708 that the UE receives over its aligned beam focusing range, the UE may perform measurements 712 to evaluate the beam's quality. The measurements may be used to obtain parameters such as SNR, SINR, or RSRP. The UE may utilize these measurements to determine the effectiveness of each beam in terms of providing a strong and reliable communication link. This process may be repeated multiple times to ensure that the UE has sufficient data to make an informed decision on the best or optimal beam for subsequent communication. For example, the UE may use the sequence of measurements 712 to compare the performance of different beams and select the one that offers the best link quality.

After completing the measurements, the UE may send P-2 feedback 714 to the base station. This feedback 714 may include a recommendation 716 for the best beam, based on the measurements 712 taken previously. From this feedback, the base station may adjust its beamforming strategy and select the optimal beam for communication. The recommendation 716 may include the angle and range of the best beam, allowing the base station to focus its transmission efforts on the most effective beam. Similarly, at block 718, the UE may adjust its transmission beam or reception beam for subsequent communication to align with the range of the optimal beam indicated in the feedback 714. Thus, both the UE and base station may communicate using the most effective transmission and reception beams.

In some cases where the subsequent communication is position-based, then at block 720, the UE may determine its position based at least in part on this best beam focusing range, such as through triangulation. Afterwards, the UE may communicate with the base station based on this determined position for navigation or other position-based services. The UE and base station may then communicate data 722 to or from each other using the updated optimal beam direction and focusing range.

The sequence depicted in FIG. 7 may be repeated over time to account for changes in the communication environment. For example, as the UE moves or as the signal conditions change, the base station may reconfigure the P-2 beams 708 in another instance of RRC configuration 706. This configuration 706 may include same or different angle or range information regarding each transmission beam, LUT, reference signal, or the like as in the prior configuration, which new information may be similarly indicated via field 604 or otherwise according to any one or more of the approaches previously described with respect to FIG. 6. Likewise, the UE may perform another round of measurements 712 in response to the new instances of P-2 beams 708, and a new optimal beam may be selected. This dynamic adjustment allows for the communication link to remain optimized, providing the best possible performance under varying conditions.

Accordingly, the beam refinement process in various aspects of the present disclosure allows the base station to transmit beams periodically, including scanning beams in different directions and focus ranges, with the UE performing measurements and sending back recommendations for the best beam. The UE may perform its own calculations and adjustments based on the focus range, thereby determining the best focus range for the serving beam. As a result of the base station carefully configuring and the UE similarly measuring the CSI-RS or other reference signal P-2 beams with these beam focusing ranges, the base station and UE may work together to identify the best beam for transmission in near-field wireless systems, enhancing the overall quality and reliability of the communication link.

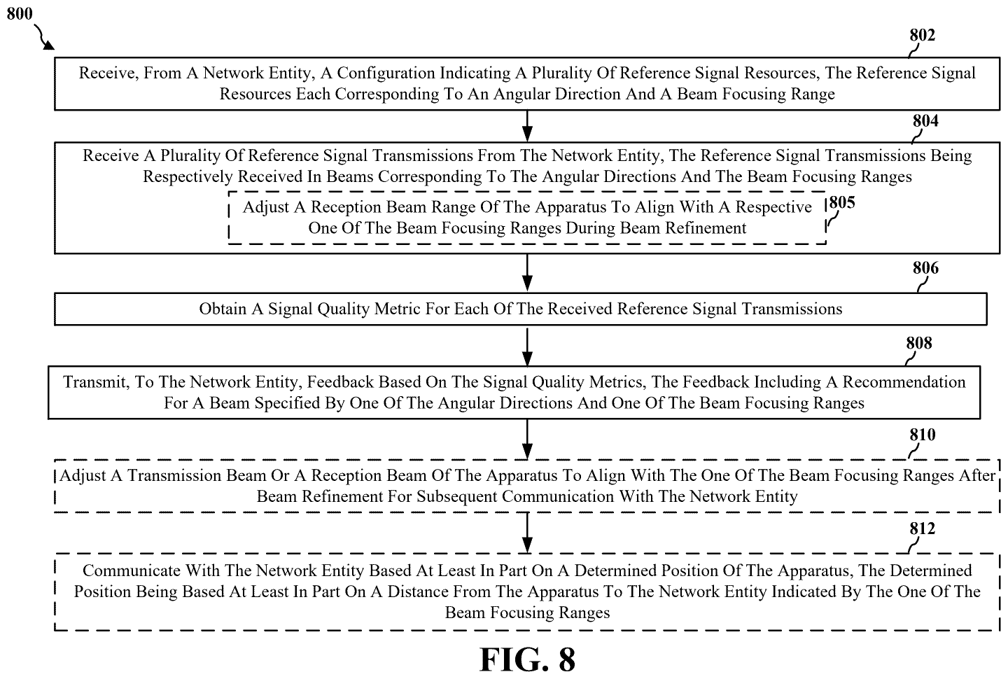

FIG. 8 is a flowchart 800 of an example method or process for wireless communication. The method may be performed by a UE such as the UE 104, 350, or apparatus 902 or its components as described herein. Optional aspects are illustrated in dashed lines. The method allows for enhancement of the beam refinement process by indicating and utilizing beam focusing ranges in near-field communication for mmW (or higher frequency ranges such as sub-Terahertz) systems.

At block 802, the UE may receive, from a network entity, a configuration indicating a plurality of reference signal resources, the reference signal resources each corresponding to an angular direction and a beam focusing range. For example, block 802 may be performed by configuration component 940. For instance, referring to the Figures, the controller(s)/processor(s) 359, the RX processor(s) 356, or a combination of these processor(s) of UE 704 may decode, demodulate, and receive via antennas 352, from base station 702, RRC configuration 706 indicating CSI-RS resources. For example, the RRC configuration 706 may include multiple instances of NZP-CSI-RS-Resource shown in block 602 with different resource identifiers, each corresponding to a different CSI-RS resource. The CSI-RS resources may each correspond to an angular direction, such as one of the steering directions illustrated in examples 400 or 450, and a beam focusing range, such as one of the ranges illustrated in examples 510, 520, or 530.

At block 804, the UE may receive a plurality of reference signal transmissions from the network entity, the reference signal transmissions being respectively received in beams corresponding to the angular directions and the beam focusing ranges. For example, block 804 may also be performed by reference signal component 942. For instance, referring to the Figures, the controller(s)/processor(s) 359, the RX processor(s) 356, or a combination of these processor(s) of UE 704 may decode, demodulate, and receive via antennas 352, from base station 702, CSI-RS in different P-2 beams 708. The CSI-RS may be received over same or different steering directions given by angle Phi in FIG. 7, and over same or different ranges given by distance Rj in FIG. 7. For example, the UE may receive CSI-RSs over different ones of the steering directions illustrated in examples 400 or 450, and within each of these steering directions, over different ones of the beam focusing ranges illustrated in examples 510, 520, or 530.

At block 805, the UE may adjust a reception beam range of the UE to align with a respective one of the beam focusing ranges during beam refinement. For example, block 805 may be performed by beam adjustment component 948. For instance, referring to the Figures, the controller(s)/processor(s) 359 may at block 710, during the P-2 process, adjust its reception beams so that their beam focusing ranges align with the respective ranges or distances Rj configured in RRC configuration 706 for each beam 708. For example, the controller(s)/processor(s) 359 may access the RRC configuration 706 to get the beam focusing range for a given beam, calculate a change in phase and amplitude for the antenna elements to shift the focus range to the specified beam focusing range, and instruct the RX processor(s) 356 to shift the antennas 352 accordingly. Thus, if, for example, the RRC configuration 706 indicates that a particular beam is focused at a range of 500 meters, the UE may adjust its reception beam to focus at the same 500-meter range by changing the phase and amplitude settings of its antenna elements accordingly.

At block 806, the UE may obtain a signal quality metric for each of the received reference signal transmissions. For example, block 806 may be performed by signal quality component 944. For instance, referring to the Figures, after the controller(s)/processor(s) 359, the RX processor(s) 356, or a combination of these processor(s) of UE 704 decode, demodulate, and receive via antennas 352 the CSI-RSs over P-2 beams 708, the controller(s)/processor(s) 359 may perform measurements 712 of the signal strength or quality of each beam 708. From each of these measurements 712, the controller(s)/processor(s) 359 may derive or calculate an SNR, SINR, or RSRP associated with respective ones of the beams 708.

At block 808, the UE may transmit, to the network entity, feedback based on the signal quality metrics, the feedback including a recommendation for a beam specified by one of the angular directions and one of the beam focusing ranges. For example, block 808 may be performed by feedback component 946. For instance, referring to the Figures, the controller(s)/processor(s) 359, the TX processor(s) 368, or a combination of these processor(s) of UE 704 may encode, modulate, and transmit via antennas 352, P-2 feedback 714. The P-2 feedback 714 may indicate, via recommendation 716, the P-2 beam 708 with the angle and range having the best SNR, SINR, or RSRP the UE derived from measurements 712. The recommendation 716 may also indicate information identifying this angle and range of the optimal beam, such as the angle Phi, the distance Rj, or a combination of the foregoing,. For example, the recommendation 716 may include the resource identifier of the CSI-RS associated with the best angle and range, the beam focusing range identified to be optimal, a combination of the foregoing, or other information.

At block 810, the UE may adjust a transmission beam or a reception beam of the UE to align with the one of the beam focusing ranges after beam refinement for subsequent communication with the network entity. For example, block 810 may be performed by beam adjustment component 948. For instance, referring to the Figures, the controller(s)/processor(s) 359, the RX processor(s) 356, the TX processor(s) 368, or a combination of these processor(s) of UE 704 may at block 718, after the P-2 process, adjust its transmission beams or reception beams in a similar manner to that described with respect to block 805. The adjustment may be made such that the beam focusing range of the UE's transmission beam or reception beam aligns with the respective range or distance Rj configured in RRC configuration 706 for the optimal one of beams 708 determined to have the best SNR, SINR, or RSRP from measurements 712. Using this best beam, the UE and base station may subsequently and effectively communicate data 722 with each other.

At block 812, the UE may communicate with the network entity based at least in part on a determined position of the UE, the determined position being based at least in part on a distance from the UE to the network entity indicated by the one of the beam focusing ranges. For example, block 812 may be performed by position component 950. For instance, referring to the Figures, the controller(s)/processor(s) 359 may at block 720, after the P-2 process, triangulate its position with respect to base station 702. The triangulation or other position determination may be performed using the range or distance Rj indicated by the beam focusing range configured in RRC configuration 706 for the optimal one of beams 708 determined to have the best SNR, SINR, or RSRP from measurements 712. The UE and base station may then effectively communicate data 722 with each other based on this determined position, for example when applying emergency or other position-based services.

In various examples, the configuration may indicate the beam focusing ranges corresponding to the reference signal transmissions. More particularly, each of the beam focusing ranges may be respectively indicated via a field of a reference signal resource parameter included in the configuration. For instance, referring to the Figures, RRC configuration 706 may indicate the range or distance Rj corresponding to the P-2 beams 708 carrying CSI-RS. For example, RRC configuration 706 may include in block 602, representing the NZP-CSI-RS-Resource associated with each P-2 beam 708, the beam focusing range associated with that CSI-RS resource. This beam focusing range may in various examples be indicated expressly, for example, via field 604 of the reference signal resource parameter given by NZP-CSI-RS-Resource. The field 604 may indicate any of the range distances illustrated and described with respect to FIG. 6. For instance, the indicated beam focusing ranges may include absolute beam focusing range distance 606, differential beam focusing range distance 610, or selected range interval 614.

In one example, the field may include a fixed point binary representation of an integer corresponding to an absolute beam focusing range distance. For example, field 604 may include the fixed point, binary representation 608 of a number corresponding to absolute beam focusing range distance 606, as previously described with respect to FIG. 6. In another example, the field may include a fixed point binary representation of an integer corresponding to a differential beam focusing range distance relative to a current serving beam of the network entity. For example, field 604 may include the fixed point, binary representation 612 of a number corresponding to differential beam focusing range distance 610 relative to a current serving beam of base station 702, as previously described with respect to FIG. 6.

In a further example, the field may include a fixed point binary representation of an integer corresponding to a selected range interval from a look-up table including a plurality of range intervals of beam focusing range distances. For example, field 604 may include the fixed point, binary representation 616 of a number corresponding to the selected range interval 614 from LUT 618, where LUT 618 includes range intervals 622 of absolute beam focusing range distances, as previously described with respect to FIG. 6. In another example, the field may include a fixed point binary representation of an integer corresponding to a selected range interval from a look-up table including a plurality of range intervals of differential beam focusing range distances relative to a current serving beam of the network entity. For example, field 604 may include the fixed point, binary representation 616 of a number corresponding to the selected range interval 614 from LUT 618, where LUT 618 includes range intervals 623 of differential beam focusing range distances, as previously described with respect to FIG. 6. In a further example, the field may include a fixed point binary representation of an integer corresponding to a selected range interval from a look-up table, and the configuration indicates an update to the look-up table. For example, field 604 may include the fixed point, binary representation 616 of a number corresponding to the selected range interval 614 from LUT 618, and RRC configuration 706 or block 602 may further indicate update 624 to LUT 618, as previously described with respect to FIG. 6.

In an additional example, the configuration may indicate whether the field includes a fixed point binary representation of an integer corresponding to one of: an absolute beam focusing range distance, a differential beam focusing range distance relative to a current serving beam of the network entity, or a selected range interval from a look-up table including a plurality of range intervals of beam focusing range distances. For example, RRC configuration 706 or block 602 may indicate, for instance via type 626, whether field 604 includes the fixed point, binary representation 608 of a number corresponding to absolute beam focusing range distance 606, the fixed point, binary representation 612 of a number corresponding to differential beam focusing range distance 610 relative to a current serving beam of base station 702, or the fixed point, binary representation 616 of a number corresponding to the selected range interval 614 from LUT 618, where LUT 618 includes range intervals 622 or 623 of absolute or differential beam focusing range distances, as previously described with respect to FIG. 6.

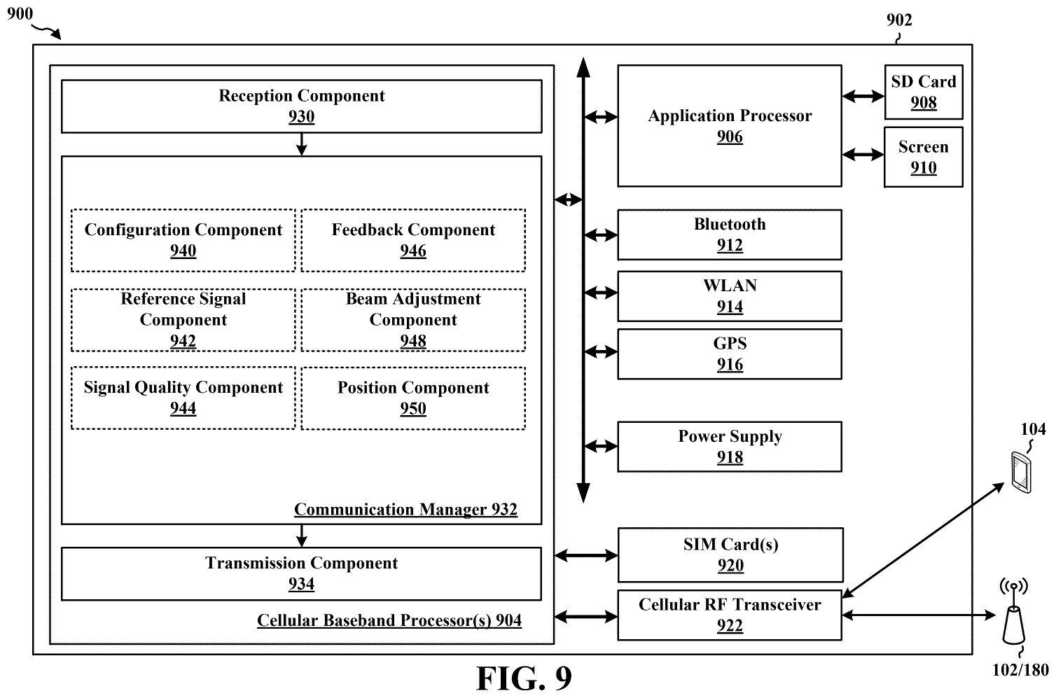

FIG. 9 is a diagram 900 illustrating an example of a hardware implementation for an apparatus 902 according to the various aspects of the present disclosure. In one example, the apparatus 902 may be a UE such as UE 104, 350, 704 and includes one or more cellular baseband processors 904 (also referred to as a modem) coupled to a cellular RF transceiver 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The one or more cellular baseband processors 904 communicate through the cellular RF transceiver 922 with the BS 102 or another UE 104. For example, the cellular RF transceiver 922 may correspond to or include the transmitters 354TX, receivers 354RX, and antennas 352 of UE 350.

The one or more cellular baseband processors 904 may each include a computer-readable medium/one or more memories. The computer-readable medium/one or more memories may be non-transitory. The one or more cellular baseband processors 904 are responsible for general processing, including the execution of software stored on the computer-readable medium/one or more memories individually or in combination. The software, when executed by the one or more cellular baseband processors 904, causes the one or more cellular baseband processors 904 to, individually or in combination, perform the various functions described supra. The computer-readable medium/one or more memories may also be used individually or in combination for storing data that is manipulated by the one or more cellular baseband processors 904 when executing software. The one or more cellular baseband processors 904 individually or in combination further include a reception component 930, a communication manager 932, and a transmission component 934. The communication manager 932 includes the one or more illustrated components. The components within the communication manager 932 may be stored in the computer-readable medium/one or more memories and/or configured as hardware within the one or more cellular baseband processors 904. The one or more cellular baseband processors 904 may be components of the UE 104, 350, 704, and may individually or in combination include the one or more memories 360 and/or at least one of the one or more TX processors 368, at least one of the one or more RX processors 356 and at least one of the one or more controllers/processors 359. For example, the computer-readable medium/one or more memories may correspond to or include the one or more memories 360, the reception component 930 may correspond to or include the one or more RX processors 356, the communication manager 932 may correspond to or include the one or more controllers/processors 359, and the transmission component 934 may correspond to or include the one or more TX processors 368. In one configuration, the apparatus 902 may be a modem chip and include just the one or more baseband processors 904, and in another configuration, the apparatus 902 may be the entire UE (e.g., UE 350 of FIG. 3) and include the aforediscussed additional modules of the apparatus 902.

The communication manager 932 may include a configuration component 940 that is configured to receive, from a network entity, a configuration indicating a plurality of reference signal resources, the reference signal resources each corresponding to an angular direction and a beam focusing range, such as described in connection with block 802 of FIG. 8. The communication manager 932 may further include a reference signal component 942 that is configured to receive a plurality of reference signal transmissions from the network entity, the reference signal transmissions being respectively received in beams corresponding to the angular directions and the beam focusing ranges, such as described in connection with block 804 of FIG. 8. The communication manager 932 may further include a signal quality component 944 that is configured to obtain a signal quality metric for each of the received reference signal transmissions, such as described in connection with block 806 of FIG. 8. The communication manager 932 may further include a feedback component 946 that is configured to transmit, to the network entity, feedback based on the signal quality metrics, the feedback including a recommendation for a beam specified by one of the angular directions and one of the beam focusing ranges, such as described in connection with block 808 of FIG. 8. The communication manager 932 may further include a beam adjustment component 948 that is configured to adjust a reception beam range of the apparatus to align with a respective one of the beam focusing ranges during beam refinement, such as described in connection with block 805 of FIG. 8. In one configuration, the beam adjustment component 948 may be configured to adjust a transmission beam or a reception beam of the apparatus to align with the one of the beam focusing ranges after beam refinement for subsequent communication with the network entity, such as described in connection with block 810 of FIG. 8. The communication manager 932 may further include a position component 950 that is configured to communicate with the network entity based at least in part on a determined position of the apparatus, the determined position being based at least in part on a distance from the apparatus to the network entity indicated by the one of the beam focusing ranges, such as described in connection with block 812 of FIG. 8.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 902, and in particular the one or more cellular baseband processors 904, includes means for receiving, from a network entity, a configuration indicating a plurality of reference signal resources, the reference signal resources each corresponding to an angular direction and a beam focusing range; the means for receiving being further configured to receive a plurality of reference signal transmissions from the network entity, the reference signal transmissions being respectively received in beams corresponding to the angular directions and the beam focusing ranges; means for obtaining a signal quality metric for each of the received reference signal transmissions; and means for transmitting, to the network entity, feedback based on the signal quality metrics, the feedback including a recommendation for a beam specified by one of the angular directions and one of the beam focusing ranges.

In one configuration, the apparatus 902, and in particular the one or more cellular baseband processors 904, may include means for adjusting a reception beam range of the apparatus to align with a respective one of the beam focusing ranges during beam refinement. In one configuration, the apparatus 902, and in particular the one or more cellular baseband processors 904, may include means for adjusting a transmission beam or a reception beam of the apparatus to align with the one of the beam focusing ranges after beam refinement for subsequent communication with the network entity. In one configuration, the apparatus 902, and in particular the one or more cellular baseband processors 904, may include means for communicating with the network entity based at least in part on a determined position of the apparatus, the determined position being based at least in part on a distance from the apparatus to the network entity indicated by the one of the beam focusing ranges.

The aforementioned means may be one or more of the aforementioned components of the apparatus 902 configured to perform the functions recited by the aforementioned means. Moreover, as described supra, the apparatus 902 may include the one or more TX processors 368, the one or more RX processors 356, and the one or more controllers/processors 359. As such, in one configuration, the aforementioned means may be at least one of the one or more TX processors 368, at least one of the one or more RX processors 356, or at least one of the one or more controllers/processors 359, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: receive, from a network entity, a configuration indicating a plurality of reference signal resources, the reference signal resources each corresponding to an angular direction and a beam focusing range; receive a plurality of reference signal transmissions from the network entity, the reference signal transmissions being respectively received in beams corresponding to the angular directions and the beam focusing ranges; obtain a signal quality metric for each of the received reference signal transmissions; and transmit, to the network entity, feedback based on the signal quality metrics, the feedback including a recommendation for a beam specified by one of the angular directions and one of the beam focusing ranges.

Clause 2. The apparatus of clause 1, wherein the one or more processors, individually or in any combination, are further operable to cause the apparatus to: adjust a reception beam range of the apparatus to align with a respective one of the beam focusing ranges during beam refinement.

Clause 3. The apparatus of clause 1 or clause 2, wherein the one or more processors, individually or in any combination, are further operable to cause the apparatus to: adjust a transmission beam or a reception beam of the apparatus to align with the one of the beam focusing ranges after beam refinement for subsequent communication with the network entity.

Clause 4. The apparatus of any of clauses 1 to 3, wherein the one or more processors, individually or in any combination, are further operable to cause the apparatus to: communicate with the network entity based at least in part on a determined position of the apparatus, the determined position being based at least in part on a distance from the apparatus to the network entity indicated by the one of the beam focusing ranges.

Clause 5. The apparatus of any of clauses 1 to 4, wherein the configuration indicates the beam focusing ranges corresponding to the reference signal transmissions.

Clause 6. The apparatus of any of clauses 1 to 5, wherein each of the beam focusing ranges is respectively indicated via a field of a reference signal resource parameter included in the configuration.

Clause 7. The apparatus of clause 6, wherein the field includes a fixed point binary representation of an integer corresponding to an absolute beam focusing range distance.

Clause 8. The apparatus of clause 6, wherein the field includes a fixed point binary representation of an integer corresponding to a differential beam focusing range distance relative to a current serving beam of the network entity.

Clause 9. The apparatus of clause 6, wherein the field includes a fixed point binary representation of an integer corresponding to a selected range interval from a look-up table including a plurality of range intervals of beam focusing range distances.

Clause 10. The apparatus of clause 6, wherein the field includes a fixed point binary representation of an integer corresponding to a selected range interval from a look-up table including a plurality of range intervals of differential beam focusing range distances relative to a current serving beam of the network entity.

Clause 11. The apparatus of any of clauses 6, 9, and 10, wherein the field includes a fixed point binary representation of an integer corresponding to a selected range interval from a look-up table, and the configuration indicates an update to the look-up table.

Clause 12. The apparatus of any of clauses 6 to 11, wherein the configuration indicates whether the field includes a fixed point binary representation of an integer corresponding to one of: an absolute beam focusing range distance, a differential beam focusing range distance relative to a current serving beam of the network entity, or a selected range interval from a look-up table including a plurality of ranges of beam focusing range distances.

Clause 13. A method of wireless communication performable at a user equipment (UE), comprising: receiving, from a network entity, a configuration indicating a plurality of reference signal resources, the reference signal resources each corresponding to an angular direction and a beam focusing range; receiving a plurality of reference signal transmissions from the network entity, the reference signal transmissions being respectively received in beams corresponding to the angular directions and the beam focusing ranges; obtaining a signal quality metric for each of the received reference signal transmissions; and transmitting, to the network entity, feedback based on the signal quality metrics, the feedback including a recommendation for a beam specified by one of the angular directions and one of the beam focusing ranges.

Clause 14. The method of clause 13, wherein each of the beam focusing ranges is respectively indicated via a field of a reference signal resource parameter included in the configuration.

Clause 15. The method of clause 14, wherein the field includes a fixed point binary representation of an integer corresponding to an absolute beam focusing range distance.

Clause 16. The method of clause 14, wherein the field includes a fixed point binary representation of an integer corresponding to a differential beam focusing range distance relative to a current serving beam of the network entity.

Clause 17. The method of clause 14, wherein the field includes a fixed point binary representation of an integer corresponding to a selected range interval from a look-up table including a plurality of range intervals of beam focusing range distances.

Clause 18. The method of clause 14, wherein the field includes a fixed point binary representation of an integer corresponding to a selected range interval from a look-up table including a plurality of range intervals of differential beam focusing range distances relative to a current serving beam of the network entity.

Clause 19. The method of any of clauses 14 to 18, wherein the configuration indicates whether the field includes a fixed point binary representation of an integer corresponding to one of: an absolute beam focusing range distance, a differential beam focusing range distance relative to a current serving beam of the network entity, or a selected range interval from a look-up table including a plurality of range intervals of beam focusing range distances.

Clause 20. An apparatus for wireless communication, comprising: means for receiving, from a network entity, a configuration indicating a plurality of reference signal resources, the reference signal resources each corresponding to an angular direction and a beam focusing range; the means for receiving being further configured to receive a plurality of reference signal transmissions from the network entity, the reference signal transmissions being respectively received in beams corresponding to the angular directions and the beam focusing ranges; means for obtaining a signal quality metric for each of the received reference signal transmissions; and means for transmitting, to the network entity, feedback based on the signal quality metrics, the feedback including a recommendation for a beam specified by one of the angular directions and one of the beam focusing ranges.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
receive, from a network entity, a configuration indicating a plurality of reference signal resources, the reference signal resources each corresponding to an angular direction and a beam focusing range;
receive a plurality of reference signal transmissions from the network entity, the reference signal transmissions being respectively received in beams corresponding to the angular directions and the beam focusing ranges;
obtain a signal quality metric for each of the received reference signal transmissions; and
transmit, to the network entity, feedback based on the signal quality metrics, the feedback including a recommendation for a beam specified by one of the angular directions and one of the beam focusing ranges.

2. The apparatus of claim 1, wherein the one or more processors, individually or in any combination, are further operable to cause the apparatus to:
adjust a reception beam range of the apparatus to align with a respective one of the beam focusing ranges during beam refinement.

3. The apparatus of claim 1, wherein the one or more processors, individually or in any combination, are further operable to cause the apparatus to:
adjust a transmission beam or a reception beam of the apparatus to align with the one of the beam focusing ranges after beam refinement for subsequent communication with the network entity.

4. The apparatus of claim 1, wherein the one or more processors, individually or in any combination, are further operable to cause the apparatus to:
communicate with the network entity based at least in part on a determined position of the apparatus, the determined position being based at least in part on a distance from the apparatus to the network entity indicated by the one of the beam focusing ranges.

5. The apparatus of claim 1, wherein the configuration indicates the beam focusing ranges corresponding to the reference signal transmissions.

6. The apparatus of claim 1, wherein each of the beam focusing ranges is respectively indicated via a field of a reference signal resource parameter included in the configuration.

7. The apparatus of claim 6, wherein the field includes a fixed point binary representation of an integer corresponding to an absolute beam focusing range distance.

8. The apparatus of claim 6, wherein the field includes a fixed point binary representation of an integer corresponding to a differential beam focusing range distance relative to a current serving beam of the network entity.

9. The apparatus of claim 6, wherein the field includes a fixed point binary representation of an integer corresponding to a selected range interval from a look-up table including a plurality of range intervals of beam focusing range distances.

10. The apparatus of claim 6, wherein the field includes a fixed point binary representation of an integer corresponding to a selected range interval from a look-up table including a plurality of range intervals of differential beam focusing range distances relative to a current serving beam of the network entity.

11. The apparatus of claim 6, wherein the field includes a fixed point binary representation of an integer corresponding to a selected range interval from a look-up table, and the configuration indicates an update to the look-up table.

12. The apparatus of claim 6, wherein the configuration indicates whether the field includes a fixed point binary representation of an integer corresponding to one of:
an absolute beam focusing range distance,
a differential beam focusing range distance relative to a current serving beam of the network entity, or
a selected range interval from a look-up table including a plurality of range intervals of beam focusing range distances.

13. A method of wireless communication performable at a user equipment (UE), comprising:
receiving, from a network entity, a configuration indicating a plurality of reference signal resources, the reference signal resources each corresponding to an angular direction and a beam focusing range;
receiving a plurality of reference signal transmissions from the network entity, the reference signal transmissions being respectively received in beams corresponding to the angular directions and the beam focusing ranges;
obtaining a signal quality metric for each of the received reference signal transmissions; and
transmitting, to the network entity, feedback based on the signal quality metrics, the feedback including a recommendation for a beam specified by one of the angular directions and one of the beam focusing ranges.

14. The method of claim 13, wherein each of the beam focusing ranges is respectively indicated via a field of a reference signal resource parameter included in the configuration.

15. The method of claim 14, wherein the field includes a fixed point binary representation of an integer corresponding to an absolute beam focusing range distance.

16. The method of claim 14, wherein the field includes a fixed point binary representation of an integer corresponding to a differential beam focusing range distance relative to a current serving beam of the network entity.

17. The method of claim 14, wherein the field includes a fixed point binary representation of an integer corresponding to a selected range interval from a look-up table including a plurality of range intervals of beam focusing range distances.

18. The method of claim 14, wherein the field includes a fixed point binary representation of an integer corresponding to a selected range interval from a look-up table including a plurality of range intervals of differential beam focusing range distances relative to a current serving beam of the network entity.

19. The method of claim 14, wherein the configuration indicates whether the field includes a fixed point binary representation of an integer corresponding to one of:
an absolute beam focusing range distance,
a differential beam focusing range distance relative to a current serving beam of the network entity, or
a selected range interval from a look-up table including a plurality of range intervals of beam focusing range distances.

20. An apparatus for wireless communication, comprising:
means for receiving, from a network entity, a configuration indicating a plurality of reference signal resources, the reference signal resources each corresponding to an angular direction and a beam focusing range;
the means for receiving being further configured to receive a plurality of reference signal transmissions from the network entity, the reference signal transmissions being respectively received in beams corresponding to the angular directions and the beam focusing ranges;
means for obtaining a signal quality metric for each of the received reference signal transmissions; and
means for transmitting, to the network entity, feedback based on the signal quality metrics, the feedback including a recommendation for a beam specified by one of the angular directions and one of the beam focusing ranges.
